(19) United States
(12) Patent Application Publication
(10) Pub. No.: US 2013/0088329 A1
(43) Pub. Date: Apr. 11, 2013

(54) LIGHTABLE BRACELET SYSTEMS

(71) Applicants: Katherine Chrysostom, Columbia, SC (US); Richard J. Kasper, Swanzey, NH (US)

(72) Inventors: Katherine Chrysostom, Columbia, SC (US); Richard J. Kasper, Swanzey, NH (US)

(73) Assignee: First Solar, Inc., Perrysburg, OH (US)

(21) Appl. No.: 13/633,839

(22) Filed: Oct. 2, 2012

Related U.S. Application Data
(60) Provisional application No. 61/543,952, filed on Oct. 6, 2011.

(51) Int. Cl. G08B 5/36; A44C 5/00; G08C 17/02

(52) U.S. Cl. 340/8.1; 340/10.1; 63/1.13

(57) ABSTRACT

A smart bracelet system having a first smart bracelet and second smart bracelet. The first smart bracelet comprises a first bracelet body having a first inner volume; a first attacher; a first pocket; a first powerer; a first chip; and a first illuminator. The second smart bracelet comprising; a second bracelet body having a second inner volume; a second attacher; a second pocket; a second powerer; a second chip; and a second illuminator. The first smart bracelet and the second smart bracelet are in communication with one another. The communication uses electromagnetic waves useful to enable communication between the bracelet during periods of darkness; thus tracking means are presented.

### CROSS-REFERENCE TO RELATED APPLICATION

The present application is related to and claims priority from prior provisional application Ser. No. 61/543,952, filed Oct. 6, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of jewelry and more specifically relates to a bracelet that uses RFID technology.

2. Description of the Related Art

A bracelet is typically an article of jewelry which is worn around the wrist. Bracelets can be manufactured from metal, leather, cloth, plastic or other materials and sometimes contain jewels, rocks, wood, and/or shells; typically bracelets are used for ornamentation purposes. Bracelets may also be used for medical and identification purposes, such as allergy bracelets and hospital patient-identification tags.

Radio-frequency identification (RFID) is a technology that uses radio waves to transfer data from an electronic tag, called a RFID tag or label, attached to an object, through a reader for the purpose of identifying and tracking the object. Some RFID tags can be read from several meters away and beyond the line of sight of the reader. These devices work regardless of ambient lighting conditions.

RFID can be used in many applications. A tag can be affixed to any object and used to track and manage inventory, assets, people, etc. For example, it can be affixed to cars, computer equipment, books, mobile phones, etc. The Healthcare industry has used RFID technology to reduce counting, looking for things and auditing items. Many financial institutions use RFID to track key assets and automate compliance. Also with recent advances in social media,. RFID is being used to tie the physical world with the virtual world.

RFID technology is a superior and more efficient way of identifying objects than a manual system or use of bar code systems which have been in use since the 1970s. Furthermore, passive RFID tags (those without a battery) can be read if passed within close enough proximity to an RFID reader. It is not necessary to “show” the tag to the reader device, as with a bar code. In other words it does not require line of sight to “see” an RFID tag, the tag can be read inside a case, carton, box or other container, and unlike barcodes. RFID tags can be read hundreds at a time. Bar codes used presently can only be read one at a time.

Many individuals go on excursions with their children; however it may be difficult to keep a watchful eye on them at all times. Harnesses may be used, but are cumbersome. The chances of a child getting lost after daylight has diminished are increased. Lost children can undergo extreme stress and parents may be worried about such instances occurring. It would be useful and comforting to have a solution to the problem in place before the incident occurred.

Various attempts have been made to solve the above-mentioned problems such as those found in U.S. Pat. Nos. and Pub. Nos. 2002/0109596; 2006/0192674; 6,977,586; 2006/0180647; 7,324,000; 2002/0145522; and 6,081,194. This art is representative of functional jewelry. None of the above inventions and patents, taken either singly or in combination, is seen to describe the invention as claimed.

Ideally, a smart bracelet system, should be user-friendly, yet would operate reliably and be manufactured at a modest expense. Thus, a need exists for a reliable lightable bracelet system that provides users the ability to ascertain that they are in close proximity to one another in crowded public places and other social settings, even when the individuals are not visible to each other and to avoid the above-mentioned problems.

### BRIEF SUMMARY OF THE INVENTION

In view of the foregoing disadvantages inherent in the known jewelry art, the present invention provides a novel lightable bracelet system. The general purpose of the present invention, which will be described subsequently in greater detail, is to provide users the ability to ascertain that they are in close proximity to one another in crowded public places and other social settings, even when the individuals are not visible to each other; thus enabling effective tracking means.

A smart bracelet system is disclosed herein, in a preferred embodiment, comprising: first smart bracelet and second smart bracelet. The first smart bracelet comprises a first bracelet body having a first inner volume; a first attacher; a first pocket; a first powerer; a first chip; and a first illuminator (illumination/visual indicator means). The second smart bracelet comprises a second bracelet body having a second inner volume; a second attacher; a second pocket; a second powerer; a second chip; and a second illuminator. The first smart bracelet and the second smart bracelet are in communication with one another to use a common RF signal. The communication comprises electromagnetic waves in preferred embodiments.

As such, the first smart bracelet comprises in combination the first bracelet body having the first inner volume; the first attacher; the first pocket; the first powerer; the first chip; and the first illuminator. The second smart bracelet in a similar manner comprises in combination the second bracelet body having the second inner volume; the second attacher; the second pocket; the second powerer; the second chip; and the second illuminator. The first bracelet body and the second smart bracelet are formed to removably fit independently about at least one body appendage (each on a separate individual). The first smart bracelet and the second smart bracelet each comprise fabric in preferred embodiments. The first attacher and the second attacher both preferably comprise hook and loop fasteners; and other fastening means may be used. The first and second inner volumes (external sleeves) are able to hold first and second decorative indicia inserts respectively, as per user-preference.

The first illuminator and the second illuminator comprise a least one LED each. Other suitable low power lighting means may also be used. The LED is able to emit a non-intermittent steady light, and a pulse. The pulse is able to produce a twinkling mode and a flashing mode. The first bracelet body and the second smart bracelet are able to indicate a relative proximity of each other via frequency of the pulses. In this way the first smart bracelet and the second smart bracelet are able to indicate relative proximity by lighting effects. A first user typically comprises an adult (parent, caregiver or the like) who wears a master-bracelet while a second user comprises a child who wears a servant-bracelet. The first smart bracelet and the second smart bracelet are in communication such that the first user and the second user are able to track a location of each other via signals comprising the lighting effects.

The first powerer is removably housed within the first pocket while the second powerer is removably housed within the second pocket, respectively. The first powerer and the second powerer each comprise a battery in preferred embodiments. The first chip is powered via the first powerer and controls the first illuminator while the second chip is powered via the second powerer and controls the second illuminator. The first smart bracelet and the second smart bracelet each comprise an on/off switch located on the first electromagnetic chip and the second electromagnetic chip. The electromagnetic chip is run off of 2.4 G RF solution in preferred embodiments.

The smart bracelet system may further comprise a kit including the first smart bracelet; the second smart bracelet; and a plurality of first and second decorative indicia inserts. Other bracelets may be included for example a plurality of servant bracelets linked to one master bracelet or combinations thereof.

A method of using a smart bracelet system comprises the steps of: donning a master-bracelet onto an adult wearer; donning a servant-bracelet onto a child wearer; activating the master-bracelet and the servant-bracelet such that they are in RF communication with each other; location-tracking of the adult wearer and the child wearer via the RF communication such that location-tracking is able to be visibly seen in periods of darkness.

The present invention holds significant improvements and serves as a smart bracelet system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, smart bracelet system, constructed and operative according to the teachings of the present invention.

FIG. 1 shows a perspective view illustrating a smart bracelet system in an in-use condition according to an embodiment of the present invention.

FIG. 2 is a perspective view illustrating a first smart bracelet and a second smart bracelet of the smart bracelet system according to an embodiment of the present invention of FIG. 1.

FIG. 3A is a bottom side perspective view illustrating a first chip housing a first battery external to a first pocket according to an embodiment of the present invention of FIG. 1.

FIG. 3B is a perspective view illustrating a first chip with the first battery not installed in a sleeve according to an embodiment of the present invention of FIGS. 1 and 3A.

FIG. 3C is a top side perspective view illustrating a first chip as electrically connected via wiring, the first chip external to the first pocket according to an embodiment of the present invention of FIGS. 1, 3A and 3B.

FIG. 4 is a perspective view illustrating the first smart bracelet and a second smart bracelet in close proximity to one another showing use of the smart bracelet system according to an embodiment of the present invention of FIG. 1.

FIG. 5 is a flowchart illustrating a method of use for the smart bracelet system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to an item of jewelry that uses RFID technology and more particularly to a smart bracelet system (also referred to as lightable bracelet system(s)) that provides users the ability to ascertain that they are in close proximity to one another in crowded public places and other social settings, regardless if they are visible to each other.

Generally speaking, smart bracelet system (lightable bracelet systems) includes a unique item of jewelry that activates from electromagnetic radio waves (RFID technology) in search of its ‘pair’. The bracelet may be used as a fun piece of jewelry for people of all ages to feel connected to a companion of some sort and/or it may be used by a teacher/parent (any individual responsible for multiple children at one time) as a tracker/finder device. Further, the present invention may be useful for keeping track of children or adults alike, yet allowing some independence. Smart bracelet system is not only a security component, but also functions as a fashion accessory and becomes a unique way of showing a personal connection between individuals by the identical light displays emitted by the linked devices when the wearers are in close proximity to each other.

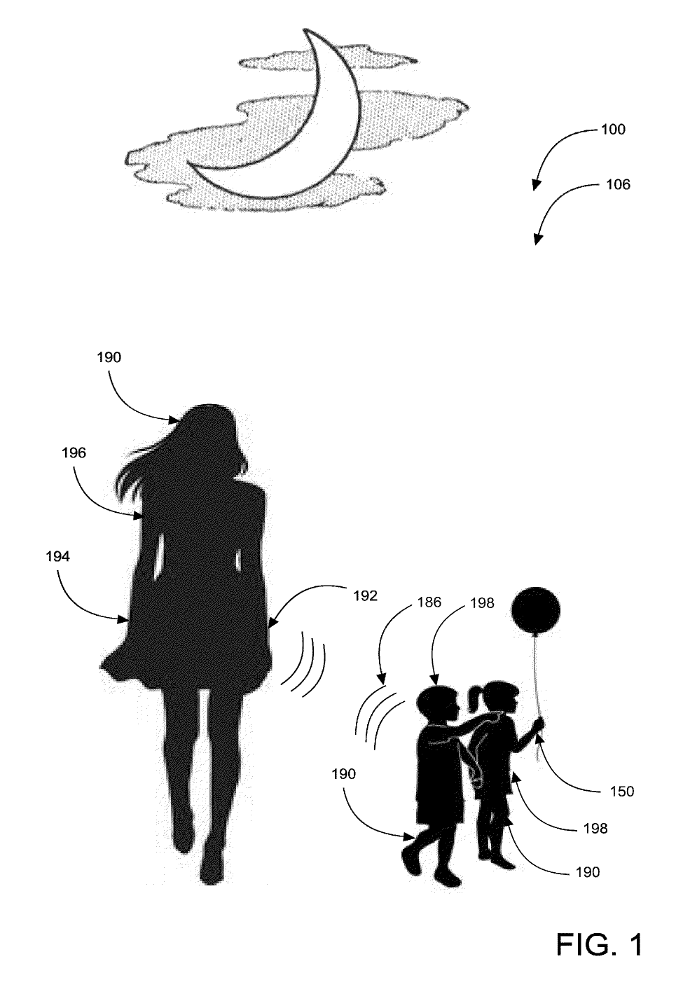

Referring to the drawings by numerals of reference there is shown in FIG. 1, a perspective view illustrating smart bracelet system 100 in in-use condition 106 according to an embodiment of the present invention.

Smart bracelet system 100 comprises first smart bracelet 110 and second smart bracelet 150. First smart bracelet 110 preferably comprises first bracelet body 114 having first inner volume 118; first attacher 122; first pocket 128; first powerer 132; first chip 136; and first illuminator 140. Second smart bracelet 150 preferably comprises second bracelet body 154 having second inner volume 158; second attacher 162; second pocket 166; second powerer 170 (first powerer 132 and second powerer 170 each preferably comprise a battery which may be rechargeable or non-rechargeable); second chip 174; and second illuminator 178. First smart bracelet 110 and second smart bracelet 150 are in communication with one another when powered. The communication comprises electromagnetic waves 186. Electromagnetic waves 186 can identify each other between a radius of approximately 10 feet-30 feet (for example: each bracelet pair (first smart bracelet 110 and second smart bracelet 150) will preferably light up together when in a proximity of 10-30 feet of one another). Distances may vary as per preference.

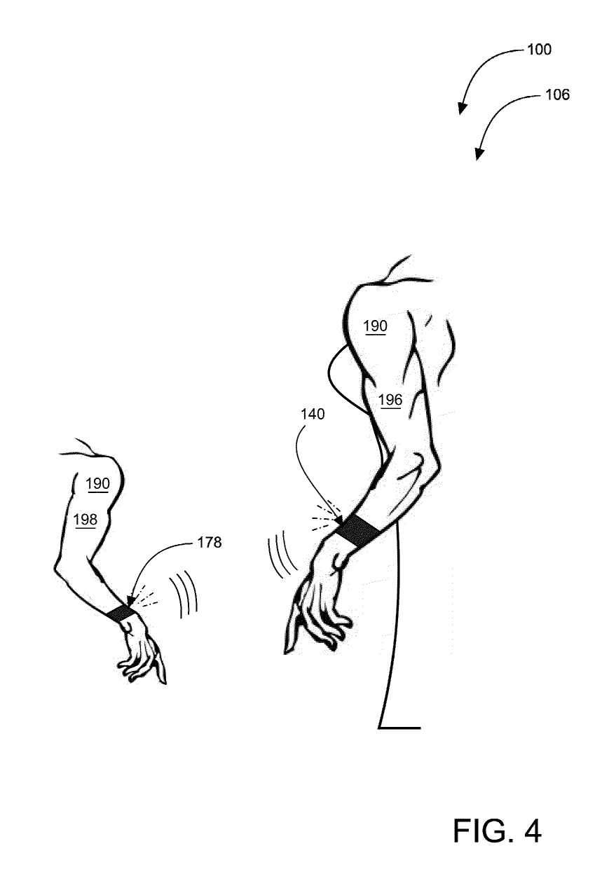

As such, first smart bracelet 110 preferably comprises in combination first bracelet body 114 having first inner volume 118; first attacher 122; first pocket 128; first powerer 132; first chip 136; and first illuminator 140. Second smart bracelet 150 preferably comprises in combination second bracelet body 154 having second inner volume 158; second attacher 162; second pocket 166; second powerer 170; second chip 174; and second illuminator 178. First bracelet body 114 and second smart bracelet 150 are formed to removably fit independently about at least one body appendage 194, as also shown in FIG. 4.

First bracelet body 114 and second smart bracelet 150 are able to indicate a relative proximity of each other. Further, in alternate embodiments the proximity range may be indicated via the brightness/dimness of at least one LED as first illuminator 140 and at least one LED as second illuminator 178 for example. Other suitable indicating means may be used. Thus, first smart bracelet 110 and second smart bracelet 150 are in communication such that first user 196 and second user 198 are able to track a location of each other.

First smart bracelet 110 and second smart bracelet 150 each preferably comprise wire ribbon covered by fabric 112, 152 (textile material) so as to bend and mold to the contours of wrist 192 of wearer 190. The wire ribbon, may differ in width dependent upon the design. Upon reading this specification, it should be appreciated that, under appropriate circumstances, considering such issues as user preferences, design preference, structural requirements, marketing preferences, cost, available materials, technological advances, etc., other material arrangements such as, for example, rubber, metal, plastic, composite, etc., may be sufficient.

First powerer 132 is removably housed within first pocket 128. Second powerer 170 is preferably removably housed within second pocket 166. First chip 136 is powered via first powerer 132 and controls first illuminator 140. Second chip 174 is powered via second powerer 170 and controls second illuminator 178. First chip 136 preferably comprises an electromagnetic chip that runs off of 2.4 G RF Solution. Additionally, second chip 174 also preferably comprises an electromagnetic chip that runs off of 2.4 G RF Solution. Those with ordinary skill in the art will now appreciate that upon reading this specification and by their understanding the art of radio frequency as described herein, methods of RF usage and solutions will be understood by those knowledgeable in such art. Both first chip 136 and second chip 174 (electromagnetic chip) are battery operated in preferred embodiments. First chip 136 may comprise first sleeve 138 while second chip 174 may comprise second sleeve 176 with both first sleeve 138 and second sleeve 176 being located on a backside for inserting a battery therein.

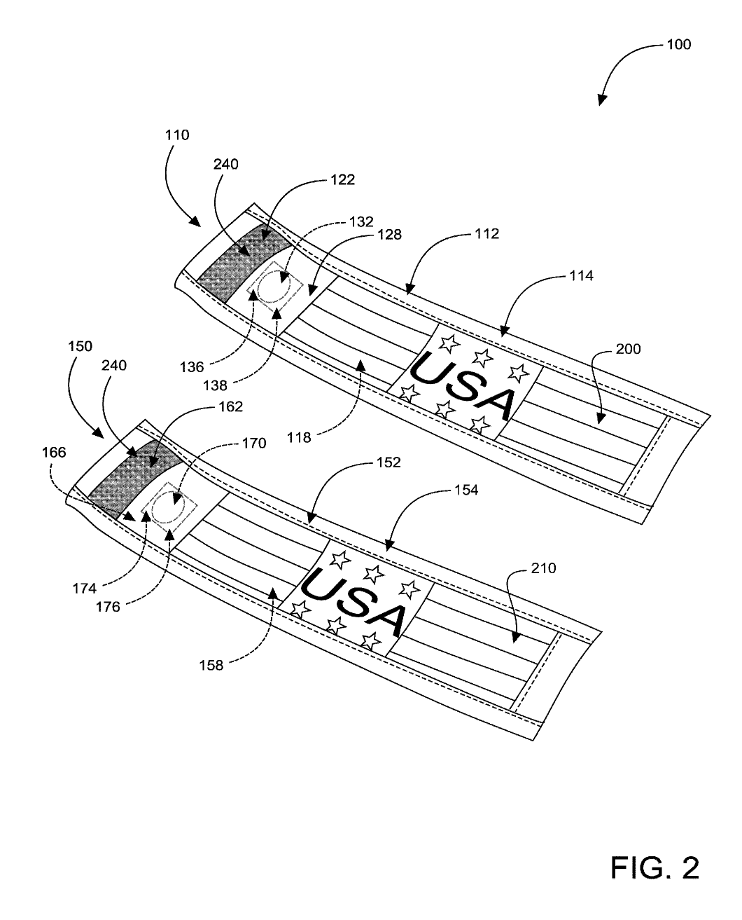

Referring now to FIG. 2 illustrating a perspective view illustrating first smart bracelet 110 and second smart bracelet 150 of smart bracelet system 100 according to an embodiment of the present invention of FIG. 1.

First inner volume 118 and second inner volume 158 are able to hold first decorative indicia insert 200 and second decorative indicia insert 210 respectively. First decorative indicia insert 200 and second decorative indicia insert 210 of smart bracelet system 100 may comprise an American flag for example as shown in FIG. 2, however other designs and themes such as popular holidays may also be manufactured. These inserts (200, 210) may be reflective to increase illumination efficiency means.

First attacher 122 and second attacher 162 preferably comprise hook and loop fasteners 240 or other suitable fastening means. Upon reading this specification, it should be appreciated that, under appropriate circumstances, considering such issues as user preferences, design preference, structural requirements, marketing preferences, cost, available materials, technological advances, etc., other fastener arrangements such as, for example, buttons, snaps, clasps, clips, etc., may be sufficient.

First illuminator 140 and second illuminator 178 preferably comprise at least one LED each. LED may comprise a non-intermittent steady light. Further, LED may comprise a pulse. The pulse may comprise a twinkling mode which does not comprise a continuous flash and/or may include a flashing mode. First smart bracelet 110 and second smart bracelet 150 preferably indicate relative proximity by lighting effects. Lighting effects and duration of flash/non-flash may be controlled by button/switch 220. Flashing mode may comprise Morse code or other communication means.

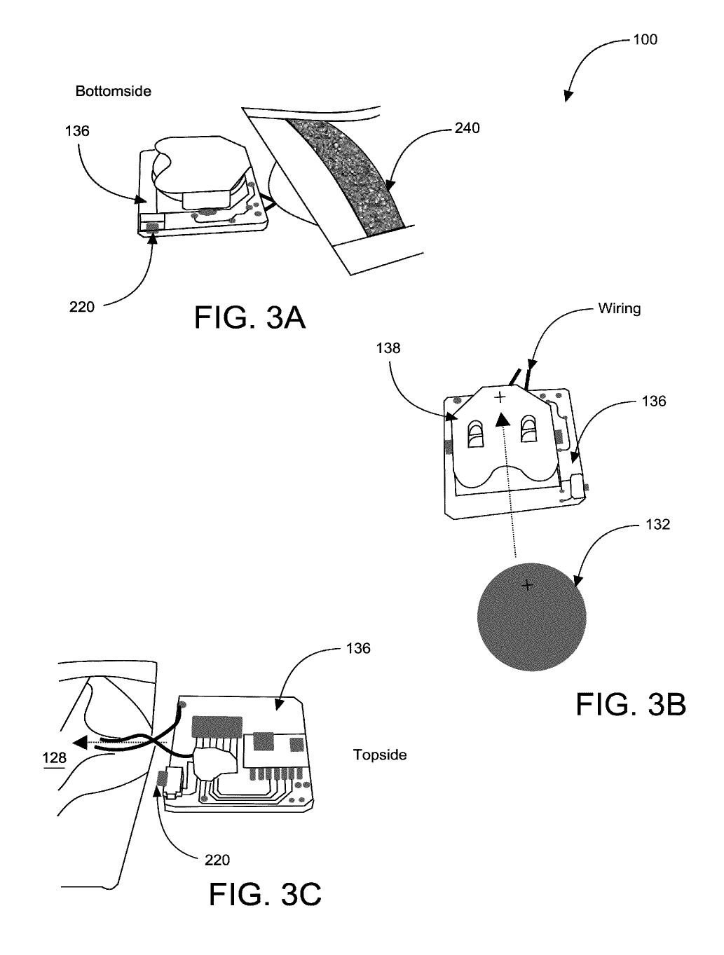

Referring generally now to FIGS. 3A-3C, showing perspective views illustrating first chip 136 of smart bracelet system 100 all according to an embodiment of the present invention of FIG. 1. FIG. 3A is bottom side perspective view illustrating first chip 136 housing a first battery (first powerer 132) external to first pocket 128. FIG. 3B is a perspective view illustrating first chip 136 with first powerer 132 not installed in first sleeve 138 according to an embodiment of the present invention of FIGS. 1 and 3A. FIG. 3C is a top side perspective view illustrating first chip 136 as electrically connected via wiring, first chip 136 external to the first pocket 128. Second smart bracelet 150 is able to be made to function in similar fashion. First sleeve 138 and second sleeve 176 keep first powerer 132 and second powerer 170 from moving about within first pocket 128 and second pocket 166, respectively.

First user 196 preferably comprises an adult (as shown in FIGS. 1 and 4) who wears a master-bracelet (first smart bracelet 110). Second user 198 preferably comprises a child who wears a servant-bracelet (second smart bracelet 150) as also shown in FIGS. 1 and 4. The master-bracelet seeks response from the servant-bracelet such that tracking may occur.

First smart bracelet 110 and second smart bracelet 150 each preferably comprise an on/off switch 220 located on first chip 136 (electromagnetic) and second chip 174 (electromagnetic). When switch 220 is indicating “ON” on BOTH bracelets in a pair, first smart bracelet 110 and second smart bracelet 150 will preferably light up properly when in close proximity to one another. If together, and wearer 190 wishes to stop the light, he/she can simply turn his/her switch 220 located on first smart bracelet 110 or second smart bracelet 150 to the “OFF” position, and the lighting will cease. First smart bracelet 110 and second smart bracelet 150 will preferably light up in whatever fashion the light setting is indicated on switch 220. Mode switches may also be included to control lighting mode.

Referring now to FIG. 4, illustrating first smart bracelet 110 and second smart bracelet 150 in close proximity to one another of smart bracelet system 100 according to an embodiment of the present invention of FIG. 1. First smart bracelet 110 and second smart bracelet 150 are indicated as having lighting modes and effects. This is useful when ambient lighting conditions are low (during periods of darkness).

Smart bracelet system 100 may be sold as kit 440 comprising the following parts: at least one first smart bracelet 110, at least one second smart bracelet 150 and a plurality of first decorative indicia inserts 200 and second decorative indicia inserts 210.

Smart bracelet system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, different indicias, parts may be sold separately, etc., may be sufficient. It should be noted that smart bracelet system 100 may be sold in pairs of two or can be sold in groups of three or more which are all unique to its “master” (i.e. the bracelet which sends electromagnetic waves in search of the others which are unique to it).

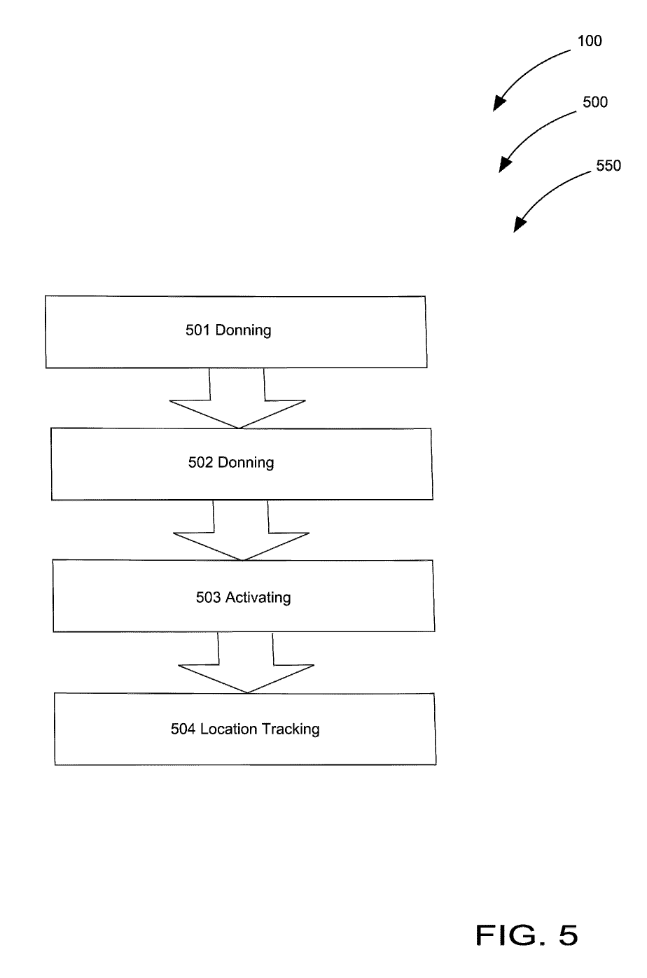

Referring now to FIG. 5, illustrating flowchart 550 illustrating a method of use 500 for smart bracelet system 100 according to an embodiment of the present invention of FIGS. 1-4.

Method of use 500 for smart bracelet system 100 preferably comprises the steps of: step one 501 donning a master-bracelet (first smart bracelet 110) onto an adult wearer (first user 196); step two 502 donning a servant-bracelet (second smart bracelet 150) onto a child wearer (second user 198); step three 503 activating the master-bracelet and the servant-bracelet such that they are in RF communication with each other; and step four 504 location-tracking of the adult wearer and the child wearer via said RF communication. The location-tracking is able to be visibly seen in periods of darkness.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A smart bracelet system comprising:
a first smart bracelet comprising;
a first bracelet body having a first inner volume;
a first attacher;
a first pocket;
a first powerer;
a first chip;
a first illuminator; and
a second smart bracelet comprising;
a second bracelet body having a second inner volume;
a second attacher;
a second pocket;
a second powerer;
a second chip; and
a second illuminator;
wherein said first smart bracelet and said second smart bracelet are in communication with one another;
wherein said communication comprises electromagnetic waves;
wherein said first smart bracelet comprises in combination said first bracelet body having said first inner volume; said first attacher; said first pocket; said first powerer; said first chip; and said first illuminator;
wherein said second smart bracelet comprises in combination said second bracelet body having said second inner volume; said second attacher; said second pocket; said second powerer; said second chip; and said second illuminator;
wherein said first bracelet body and said second smart bracelet are formed to each removably fit independently about at least one body appendage;
wherein said first bracelet body and said second smart bracelet are able to indicate a relative proximity of each other;
wherein said first powerer is removably housed within said first pocket;
wherein said second powerer is removably housed within said second pocket;
wherein said first chip is powered via said first powerer and controls said first illuminator;
wherein said second chip is powered via said second powerer and controls said second illuminator;
wherein said first chip is linked to said first powerer and said first illuminator and said second chip is linked to said second powerer and said second illuminator via wiring; and
wherein said first smart bracelet and said second smart bracelet are in said communication such that a first user and a second user are able to track a relative location of each other.

2. The smart bracelet system of claim 1 wherein said first inner volume and said second inner volume are able to hold first and second decorative indicia inserts respectively.

3. The smart bracelet system of claim 1 wherein said first illuminator and said second illuminator comprise a least one LED each.

4. The smart bracelet system of claim 1 wherein said LED comprises a non-intermittent steady light.

5. The smart bracelet system of claim 1 wherein said LED comprises a pulse.

6. The smart bracelet system of claim 5 wherein said pulse comprises a twinkling mode which does not comprise a continuous flash.

7. The smart bracelet system of claim 5 wherein said pulse comprises a flashing mode.

8. The smart bracelet system of claim 3 wherein said electromagnetic chip is run off of 2.4 G RF solution.

9. The smart bracelet system of claim 8 wherein said first attacher and said second attacher comprise hook and loop fasteners.

10. The smart bracelet system of claim 9 wherein said first user comprises an adult who wears a master-bracelet.

11. The smart bracelet system of claim 10 wherein said second user comprises a child who wears a servant-bracelet.

12. The smart bracelet system of claim 11 wherein said master-bracelet seeks response from said servant-bracelet.

13. The smart bracelet system of claim 1 wherein said first smart bracelet and said second smart bracelet each comprise an on/off switch located on said first electromagnetic chip and said second electromagnetic chip.

14. The smart bracelet system of claim 1 wherein said first smart bracelet and said second smart bracelet each comprise fabric.

15. The smart bracelet system of claim 1 wherein said first smart bracelet and said second smart bracelet indicate relative proximity by lighting effects.

16. The smart bracelet system of claim 1 wherein said first powerer and said second powerer each comprise a battery.

17. A smart bracelet system comprising:
a first smart bracelet comprising;
a first bracelet body having a first inner volume;
a first attacher;
a first pocket;
a first powerer;
a first chip;
a first illuminator; and
a second smart bracelet comprising;
a second bracelet body having a second inner volume;
a second attacher;
a second pocket;
a second powerer;
a second chip; and
a second illuminator;
wherein said first smart bracelet and said second smart bracelet are in communication with one another;
wherein said communication comprises electromagnetic waves;
wherein said first smart bracelet comprises in combination said first bracelet body having said first inner volume; said first attacher; said first pocket; said first powerer; said first chip; and said first illuminator;
wherein said second smart bracelet comprises in combination said second bracelet body having said second inner volume; said second attacher; said second pocket; said second powerer; said second chip; and said second illuminator;
wherein said first bracelet body and said second smart bracelet are each formed to removably fit independently about at least one body appendage;
wherein said first smart bracelet and said second smart bracelet each comprise fabric;
wherein said first attacher and said second attacher both comprise hook and loop fasteners;
wherein said first inner volume and said second inner volume are able to hold first and second decorative indicia inserts respectively;
wherein said first illuminator and said second illuminator comprise a least one LED each;
wherein said LED is able to emit a non-intermittent steady light, and a pulse;
wherein said pulse is able to produce a twinkling mode and a flashing mode;
wherein said first bracelet body and said second smart bracelet are able to indicate a relative proximity of each other;
wherein said first smart bracelet and said second smart bracelet indicate relative proximity by lighting effects;
wherein said first powerer is removably housed within said first pocket;
wherein said second powerer is removably housed within said second pocket;
wherein said first powerer and said second powerer each comprise a battery;
wherein said first chip is powered via said first powerer and controls said first illuminator;
wherein said second chip is powered via said second powerer and controls said second illuminator;
wherein said first smart bracelet and said second smart bracelet each comprise an on/off switch located on said first electromagnetic chip and said second electromagnetic chip;
wherein said electromagnetic chips are run off of 2.4 G RF solution;
wherein a first user comprises an adult who wears a master-bracelet;
wherein a second user comprises a child who wears a servant-bracelet; and
wherein said first smart bracelet and said second smart bracelet are in said communication such that said first user and said second user are able to track a location of each other via signals comprising said lighting effects.

18. The smart bracelet system of claim 17 further comprising a kit including at least one said first smart bracelet, at least one said second smart bracelet and a plurality of said first and second decorative indicia inserts.

19. A method of using a smart bracelet system comprising the steps of:
donning a master-bracelet onto an adult wearer;
donning a servant-bracelet onto a child wearer;
activating said master-bracelet and said servant-bracelet such that they are in RF communication with each other; and
location-tracking of said adult wearer and said child wearer via said RF communication.

20. The method of claim 19 wherein said location-tracking is able to be visibly seen in periods of darkness.
